(19) United States
(12) Patent Application Publication
(10) Pub. No.: US 2025/0376123 A1
(43) Pub. Date: Dec. 11, 2025

(54) WIDEPLATE LICENSE PLATE ACCESSORY

(71) Applicant: WIDEPLATE LLC, Saint Joseph, MI (US)

(72) Inventors: Joseph Pasquinelli, Saint Joseph, MI (US); Marco Pasquinelli, Saint Joseph, MI (US)

(73) Assignee: WIDEPLATE LLC, Saint Joseph, MI (US)

(21) Appl. No.: 18/737,612

(22) Filed: Jun. 7, 2024

(51) Int. Cl. B60R 13/10; B60Q 1/50; B60Q 1/56; G09F 7/18

(52) U.S. Cl. CPC B60R 13/105; B60Q 1/5035; G09F 7/18; B60Q 1/56; G09F 2007/1852; G09F 2007/1895

(57) ABSTRACT

A wideplate for attachment to a vehicle, comprising a body larger than a standard vehicle license plate, wherein a portion of the body extending beyond a perimeter of the license plate provides a display area, and a plurality of wideplate mounting holes, wherein the wideplate mounting holes are configured to align with license plate mounting holes to enable the wideplate to be mounted behind or in front of the vehicle license plate, such that the display area is visible beyond the perimeter of the license plate

### FIELD

WidePlate License plate accessory and method.

### BACKGROUND

License plates are a standard feature on motor vehicles and trailers, serving as a means of identification. They are typically made of metal or plastic and are affixed to the vehicle using mounting holes that align with corresponding holes on the vehicle. The size and shape of license plates are standardized in many jurisdictions, providing a uniform appearance across different vehicles.

In addition to their primary function of vehicle identification, license plates can also serve as a platform for personal expression. Vehicle owners often seek to customize their license plate numbers, frames, and/or the area surrounding them with decorative elements, such as stickers, frames, or covers. These decorative elements can reflect the owner's personal tastes, affiliations, or interests. However, the limited size of the license plate and the potential for damage to the vehicle's body can restrict the extent of such customization.

Furthermore, the mounting of license plates and any associated decorative elements typically involves the use of bolts or screws, which can be a cumbersome process requiring tools and mechanical skill. The mounting process can also be complicated by the presence of vehicle features or obstructions near the license plate area, such as power outlets or towing hooks, particularly on larger vehicles like trucks. These factors can limit the ease and flexibility of license plate customization.

### SUMMARY

In one aspect, the present disclosure relates to a wideplate for attachment to a vehicle, comprising a body larger than a standard vehicle license plate, wherein a portion of the body extending beyond a perimeter of the license plate provides a display area, and a plurality of wideplate mounting holes, wherein the wideplate mounting holes are configured to align with license plate mounting holes to enable the wideplate to be mounted behind or in front of the vehicle license plate, such that the display area is visible beyond the perimeter of the license plate.

The disclosed wideplate according to any one of the above example embodiments, wherein the body comprises a tapered edge for conforming to a contour of the vehicle.

The disclosed wideplate according to any one of the above example embodiments, wherein the display area comprises embossed or debossed features.

The disclosed wideplate according to any one of the above example embodiments, wherein the display area comprises at least a flat area for receiving stickers.

The disclosed wideplate according to any one of the above example embodiments, wherein the display area comprises mounts for receiving attachable features.

The disclosed wideplate according to any one of the above example embodiments, further comprising protective features comprising at least one of protective feet and a protective border, wherein the protective features are positioned on at least the backside of the wideplate to butt against the vehicle body.

The disclosed wideplate according to any one of the above example embodiments, further comprising at least one hinged feature allowing the display area of the wideplate to move relative to a central portion of the wideplate.

The disclosed wideplate according to any one of the above example embodiments, wherein the display area comprises a powered display configured to receive electrical power through an electrical power cord or photovoltaic battery power source.

The disclosed wideplate according to any one of the above example embodiments, further comprising at least one cutout portion configured to accommodate vehicle obstructions, wherein the cutout portion is positioned on the body of the wideplate to align with and avoid interference with vehicle features when the wideplate is mounted to the vehicle.

The disclosed wideplate according to any one of the above example embodiments, wherein the body comprises a magnetic layer, providing a capability for magnetic attachment to the vehicle.

In one aspect, the present disclosure relates to a method for installing a wideplate on a vehicle, the method comprising: positioning the wideplate in between the vehicle and a license plate; and aligning a plurality of wideplate mounting holes with license plate mounting holes to mount the wideplate behind or in front of the vehicle license plate, wherein the wideplate comprises a body larger than the license plate to the vehicle, where a portion of the body extends beyond a perimeter of the license plate providing a display area visible beyond the perimeter of the license plate.

The disclosed method according to any one of the above example embodiments, wherein the wideplate comprises a tapered edge for conforming to a contour of the vehicle, and the method further comprises aligning the tapered edge with the contour of a vehicle.

The disclosed method according to any one of the above example embodiments, wherein the wideplate comprises embossed or debossed features in the display area, and the method further comprises pressing the license plate against a central portion of the wideplate between the embossed or debossed features.

The disclosed method according to any one of the above example embodiments, wherein the wideplate comprises at least a flat area for receiving stickers in the display area, and the method further comprises applying stickers to the flat area.

The disclosed method according to any one of the above example embodiments, wherein the wideplate display area comprises mounts for receiving attachable features in the display area, and the method further comprises attaching display features to the mounts.

The disclosed method according to any one of the above example embodiments, wherein the wideplate further comprises protective features comprising at least one of protective feet and a protective border, and the method further comprises positioning the protective features against the vehicle body to prevent damage when installed.

The disclosed method according to any one of the above example embodiments, wherein the wideplate further comprises at least one hinged feature, and the method further comprises moving the display area of the wideplate relative to a central portion of the wideplate via the hinged feature during installation.

The disclosed method according to any one of the above example embodiments, wherein the wideplate comprises a powered display in the display area, and the method further comprises connecting the powered display to an electrical power source via an electrical power cord or photovoltaic battery power source during installation.

The disclosed method according to any one of the above example embodiments, wherein the wideplate further comprises at least one cutout portion configured to accommodate vehicle obstructions, and the method further comprises aligning the cutout portion with vehicle features to avoid interference during installation.

The disclosed method according to any one of the above example embodiments, wherein the wideplate comprises a magnetic layer, and the method further comprises magnetically attaching the wideplate to the vehicle during installation.

### BRIEF DESCRIPTION OF THE DRAWINGS

So that the above-recited features of the present disclosure can be understood in detail, a more particular description of the disclosure-which was only briefly summarized above—may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 is a schematic representation of a WidePlate in relation to a standard vehicle license plate, according to an example embodiment of the present disclosure.

FIG. 2 illustrates three variations of the WidePlate design, each with a different edge tapering to fit various vehicle types, according to an example embodiment of the present disclosure.

FIG. 3 depicts a WidePlate assembly with embossed areas for customization, according to an example embodiment of the present disclosure.

FIG. 4 presents top views of example WidePlates, including a standard WidePlate and a contoured WidePlate, according to an example embodiment of the present disclosure.

FIG. 5 shows a WidePlate with different attachment systems, according to an example embodiment of the present disclosure.

FIG. 6 illustrates a WidePlate with protective features, according to an example embodiment of the present disclosure.

FIG. 7 presents a WidePlate designed to accommodate various obstructions on a truck, according to an example embodiment of the present disclosure.

FIG. 8 depicts two configurations of the WidePlate design, both incorporating hinged elements, according to an example embodiment of the present disclosure.

FIG. 9A illustrates a WidePlate with powered displays, according to an example embodiment of the present disclosure.

FIG. 9B illustrates a WidePlate with illuminated displays, according to an example embodiment of the present disclosure.

FIG. 10 shows WidePlates with retractable and/or hinged side panels, according to an example embodiment of the present disclosure.

FIG. 11 presents a WidePlate illustrating its varying thickness, according to an example embodiment of the present disclosure.

FIG. 12 depicts four variations of the WidePlate design, each with a different aesthetic, according to an example embodiment of the present disclosure.

FIG. 13 illustrates an upscale model of the WidePlate, according to an example embodiment of the present disclosure.

FIG. 14 presents front and top views of a WidePlate including magnetic material, according to an example embodiment of the present disclosure.

### DETAILED DESCRIPTION

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatus as known by one of ordinary skill in the relevant art may not be discussed in detail but are intended to be part of the specification where appropriate. In all the examples illustrated and discussed herein, any specific values should be interpreted to be illustrative and non-limiting. Thus, other example embodiments may have different values. Notice that similar reference numerals and letters refer to similar items in the following figures, and thus once an item is defined in one figure, it is possible that it need not be further discussed for the following figures. Below, the example embodiments will be described with reference to the accompanying figures.

The present disclosure relates to a functional accessory for vehicles, specifically designed to enhance the aesthetic appeal and utility of a standard vehicle license plate area. This accessory, referred to herein as a “WidePlate,” is designed to be larger than a standard vehicle license plate, providing additional surface area that extends beyond the perimeter of the license plate. This additional surface area serves as a display area, which can be customized with various decorative or informational elements, such as stickers, embossed icons, electronic displays, etc.

The WidePlate includes a body that can be made from various materials, such as metal, clear acrylic, glass, plastic or a magnetic material to name a few, and can be designed in various shapes and sizes to accommodate different types of vehicles. The body of the WidePlate is equipped with mounting holes that align with the existing mounting holes of a standard vehicle license plate, thereby enabling the WidePlate to be easily and securely mounted behind the license plate. In another example, the WidePlate may be mounted in front of the license plate where the WidePlate includes a central cutout portion or transparent portion that avoids obscuring the license plate information.

In some examples, the WidePlate may include additional features to enhance its functionality and adaptability. For instance, the WidePlate may include protective features, such as protective feet, protective bumpers, or a protective border, to prevent damage to the vehicle. The WidePlate may also include hinged or retractable side panels, allowing for easy access to vehicle features or for changing the display elements. The WidePlate may also include attachment provisions for easily interchangeable display elements. In some cases, the WidePlate may include a powered display that can be digitally edited to change the displayed information or design.

The WidePlate provides an effective and easy solution for vehicle owners who wish to customize their vehicle's appearance without causing damage to the vehicle itself. By providing a customizable display area that extends beyond the perimeter of the license plate, the WidePlate allows for a wide range of decorative and informational elements to be displayed on the vehicle in a manner that is easily changeable and adaptable to the vehicle owner's preferences.

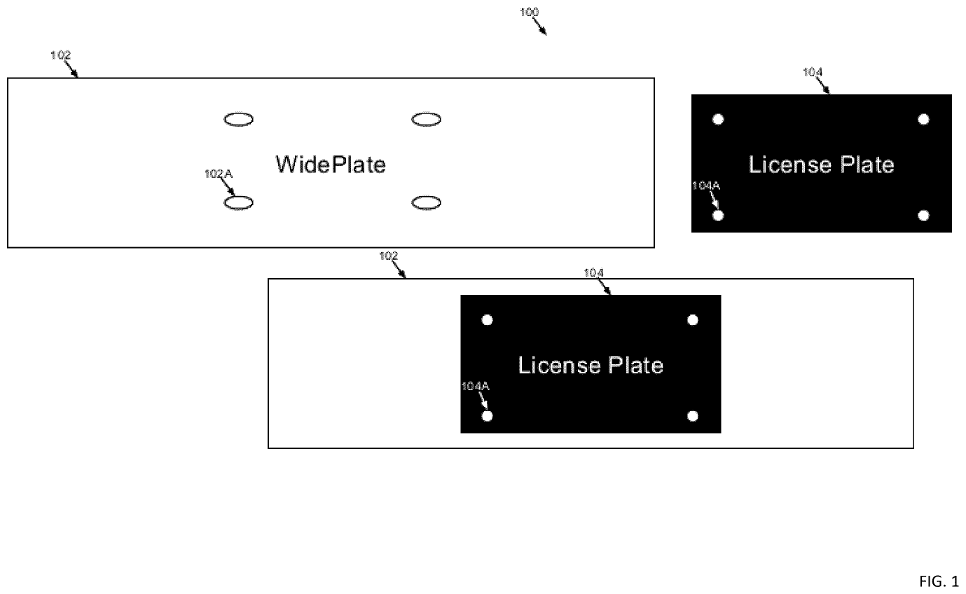

In some examples, the WidePlate 102, as depicted in view 100 of FIG. 1, may be configured to attach to a vehicle in conjunction with a standard vehicle license plate 104. The WidePlate 102 may have a body that is larger than the standard vehicle license plate 104, providing a display area that extends beyond the perimeter of the license plate. This additional surface area may serve as a display area, which can be customized with various decorative or informational elements, such as stickers, embossed icons, or electronic displays.

The WidePlate 102 may include a plurality of WidePlate mounting holes 102A. These WidePlate mounting holes 102A may be configured to align with the license plate mounting holes 104A of the license plate 104. This alignment may enable the WidePlate 102 to be mounted directly behind the vehicle license plate 104, using the same mounting points to secure both the WidePlate 102 and the license plate 104 to the vehicle.

In some cases, the WidePlate 102 may be positioned in between the vehicle and the license plate 104. This positioning may protect the vehicle from potential damage caused by the attachment of the license plate 104 and may also provide a more integrated appearance for the WidePlate 102 and the license plate 104.

In another embodiment, WidePlate 102 to be mounted in front of the vehicle license plate 104, using the same mounting points. In such a configuration, the WidePlate may include a cutout or transparent portion (not shown) to reveal the license plate. The cutout or transparent portion (e.g., clear acrylic) may be positioned (e.g., centrally) and sized (e.g., same size as the license plate) appropriately to reveal pertinent information on the license plate to the observer.

In either the back or front mounting configuration, portions (left, right, top, bottom, etc.) of WidePlate 102 extend beyond the license plate to create display areas. These display areas are designed to accommodate various decorative or informational elements, such as stickers, embossed icons, or electronic displays.

In some examples, the area of the WidePlate that is positioned behind the license plate may be designed with a flat surface or may feature a concave surface to accommodate the vehicle contour. This design consideration ensures that the WidePlate can be mounted flush with the vehicle's bodywork or provide a recessed space for the license plate, depending on the specific requirements of the vehicle or the preferences of the vehicle owner. The choice between a flat or concave surface allows for versatility in the WidePlate's application, ensuring compatibility with a variety of vehicle designs and license plate configurations.

The design of the WidePlate also takes into consideration thickness in relation to the standard vehicle license plate, ensuring that it fits snugly behind the license plate without in most cases necessitating the use of longer fasteners (e.g., bolts) or causing the license plate to protrude excessively from the vehicle body. This consideration of the WidePlate's thickness allows for a seamless integration with the vehicle's existing license plate mounting system, maintaining the vehicle's aesthetic while providing additional display area for customization. In some cases, the WidePlate may be designed with varying thicknesses to accommodate different vehicle contours or to provide a recessed area for the license plate, further enhancing the compatibility and appearance of the WidePlate when installed on the vehicle.

Installation of the WidePlate system is designed to be straightforward and user-friendly. The user aligns the WidePlate mounting holes with the corresponding license plate mounting holes and the vehicle's holes, ensuring that all holes are properly lined up. Once aligned, fasteners are inserted through these aligned holes to fasten the WidePlate, the license plate, and the vehicle body together securely. This method allows for a stable and integrated installation of the WidePlate, providing a display area for customization while maintaining the integrity and originality of the vehicle's bodywork.

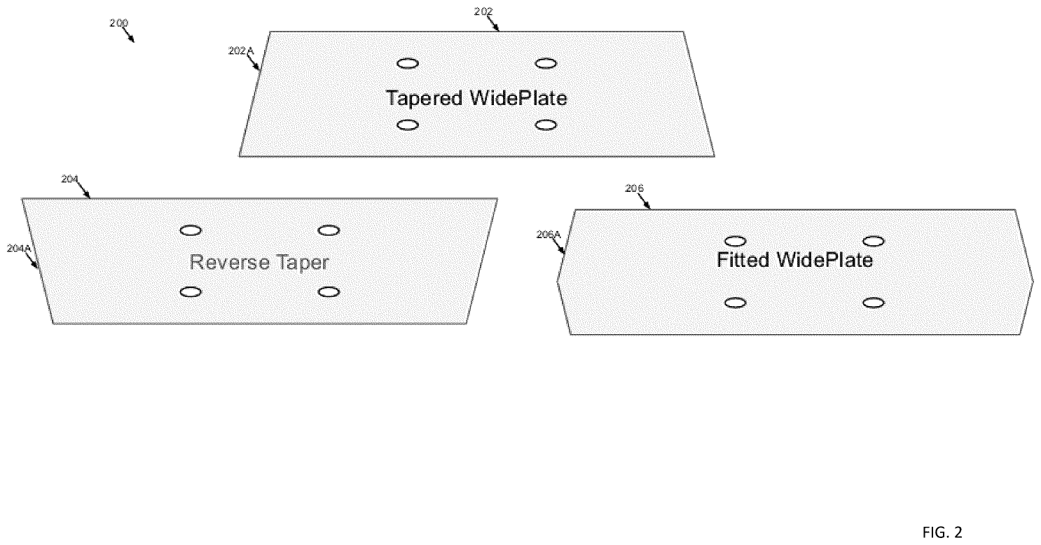

In some examples, as depicted in FIG. 2, the WidePlate may be designed with different shapes such as tapered edges to conform to the contour of the vehicle. FIG. 2 illustrates view 200 of three example variations of the WidePlate design, each tailored to fit different vehicle types with distinct edge tapering. The Tapered WidePlate 202, for instance, includes a tapered edge 202A creating a WidePlate that narrows at the top and widens at the bottom. This design may be particularly suitable for vehicles with a similar contour, allowing the WidePlate to seamlessly integrate with the vehicle's design.

In other examples, the WidePlate may feature a reverse taper, as illustrated by the Reverse Taper WidePlate 204. This design variation includes a reverse tapered edge 204A creating a WidePlate that widens at the top and narrows at the bottom. This configuration may be ideal for vehicles with a contrasting contour, providing a complementary fit.

In yet other examples, the WidePlate may present a distinct shape with a pronounced dual tapered edge, as shown by the Fitted WidePlate 206. This design variation includes a Fitted WidePlate dual tapered edge 206A creating a WidePlate that narrows at the top and bottom, while being wide in the middle. This design may accommodate vehicles with a more complex contour, ensuring a customized fit while providing additional surface area for customization.

These variations (and others) in the WidePlate design, each with a different edge tapering, are designed to accommodate the specific contouring requirements of different vehicles. This adaptability ensures that the WidePlate can be used with a wide range of vehicle types, enhancing the aesthetic appeal and utility of the vehicle's license plate while providing a customized fit. Shapes and configurations other than those shown in FIG. 2, such as circular, ovular or radiused, are of course possible.

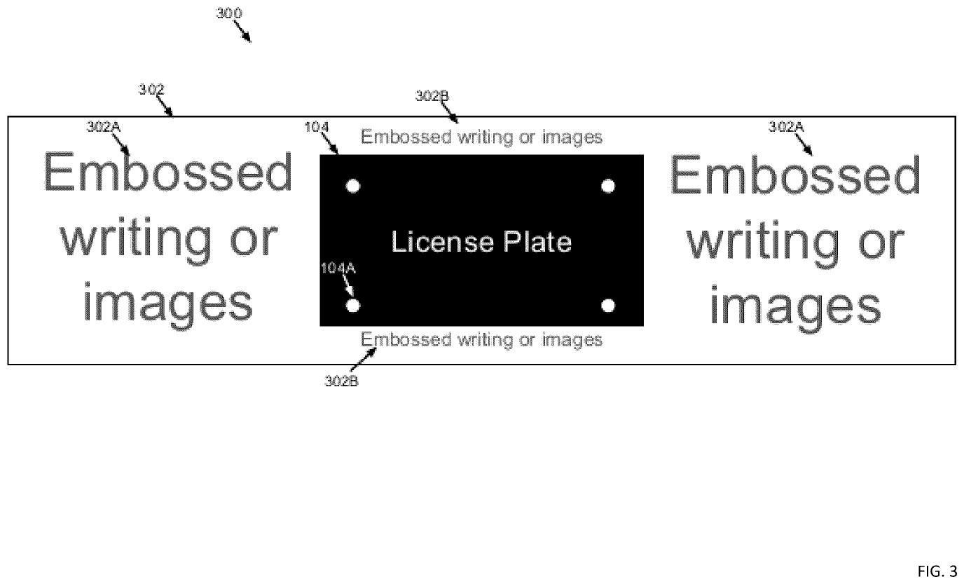

In some examples, as depicted in FIG. 3, view 300 shows that the WidePlate 302 may include embossed features in the display area. The WidePlate assembly includes the WidePlate 302 mounted behind the license plate 104. The WidePlate 302 includes left/right embossed areas 302A and top/bottom embossed areas 302B. These embossed areas 302A, 302B provide additional surface for personalization while maintaining the visibility and integrity of the central license plate 104. Other material modifications such as debossed or engraved features, are of course possible.

The embossed or debossed features may be formed by pressing or molding the material of the WidePlate 302 to create raised or recessed designs. These designs may include text, symbols, logos, or other decorative or informational elements. The embossed features may be designed to catch light and create a visually appealing effect, enhancing the aesthetic appeal of the WidePlate 302 and the vehicle to which it is attached.

In some cases, the embossed or debossed features may be colored or coated with a reflective material to increase their visibility. In other cases, the embossed or debossed features may be left uncolored or uncoated, allowing the natural color or texture of the WidePlate material to be visible.

In some examples, the WidePlate 302 may include a flat area for receiving stickers in the display area. This flat area may be located within the embossed or debossed areas 302A, 302B, providing a smooth surface for the application of stickers or other adhesive-backed decorative elements. This configuration allows for easy customization of the WidePlate 302, as stickers can be easily applied and removed without damaging the WidePlate or the vehicle.

In some cases, the WidePlate 302 may be configured to receive attachable features in the display area. These attachable features may include decorative elements, informational elements, interchangeable display areas, or functional elements that can be attached to the WidePlate 302 using various attachment mechanisms, such as clips, magnets, adhesive, or mechanical fasteners. This configuration provides additional flexibility for customizing the WidePlate 302, as the attachable features can be easily added, removed, or replaced to change the appearance or functionality of the WidePlate.

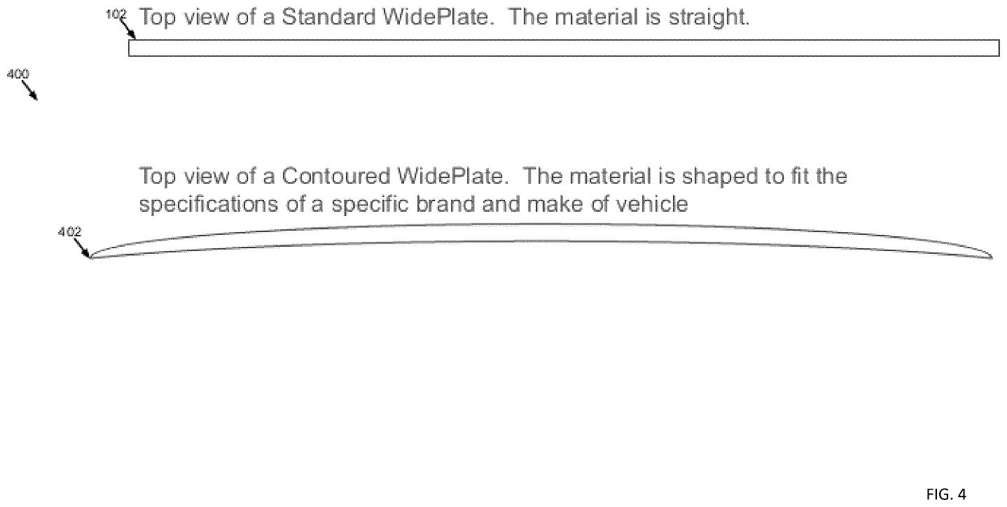

In some examples, as depicted in FIG. 4, the WidePlate may be designed to conform to the specific contour of the vehicle. FIG. 4 illustrates view 400, characterized by top views of a standard WidePlate 102 and a contoured WidePlate 402. The standard WidePlate 102 may be designed with a flat, straight surface, suitable for vehicles with a flat or straight contour around the license plate area. This design may provide a flush fit against the vehicle, ensuring a secure and stable attachment of the WidePlate 102 to the vehicle. Of course, contours from the sides are also included.

In contrast, the contoured WidePlate 402 may be designed with a curved or contoured surface, tailored to fit vehicles with a curved or contoured body around the license plate area. The contoured WidePlate 402 may be shaped to match the specific curvature of the vehicle, providing a customized fit that seamlessly integrates with the vehicle's design. This design may enhance the aesthetic appeal of the WidePlate 402 and the vehicle, while also ensuring a secure and stable attachment of the WidePlate 402 to the vehicle.

In some cases, the WidePlate, whether standard or contoured, may be designed to provide additional surface area that extends beyond the perimeter of the license plate. This additional surface area may serve as a display area, which can be customized with various decorative or informational elements. This configuration allows for a wide range of customization options, enhancing the aesthetic appeal and utility of the WidePlate and the vehicle to which it is attached.

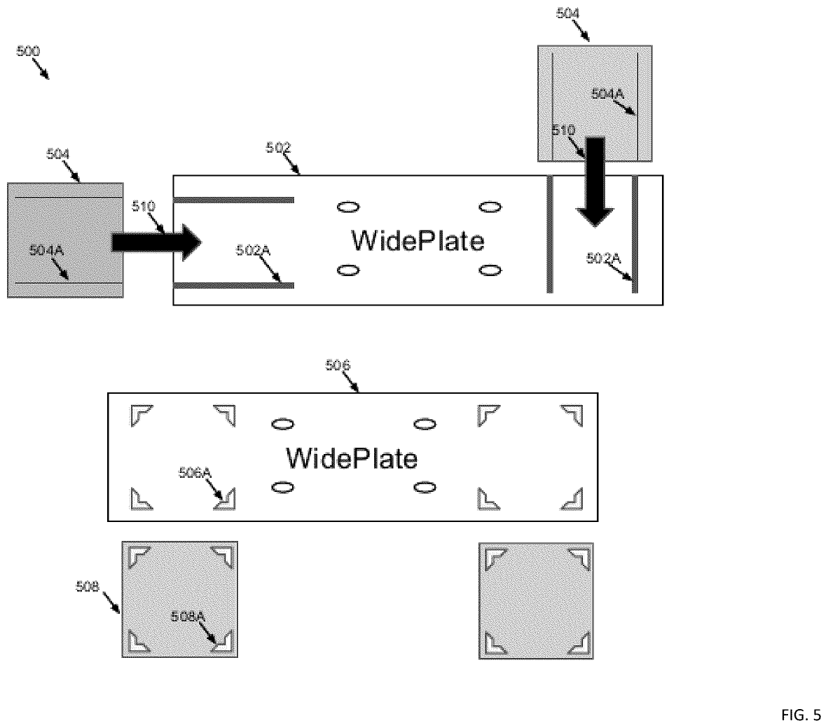

In some examples, as depicted in FIG. 5, the WidePlate 502, 506 may include mounts 502A, 506A in the display area for receiving attachable features 504, 508. FIG. 5 illustrates view 500 of WidePlate 502 having plate mounting rails 502A for receiving rail mounts 504A of rail-based attachment components 504. This configuration allows for the attachment of various features to the WidePlate 502, enhancing its functionality and adaptability. The rail-based attachment components 504 may include decorative elements, informational elements, or functional elements that can be attached to the WidePlate 502 using the rail mounts 504A. This configuration provides additional flexibility for customizing the WidePlate 502, as the rail-based attachment components 504 can be easily added, removed, or replaced to change the appearance or functionality of the WidePlate 502. For example, the rail-based attachment components 504 can be slid onto the plate mounting rails 502A of the WidePlate 502 in the direction indicated by attachment interaction arrow 510, allowing for a secure and adjustable connection.

In other examples, the WidePlate 506 may include plate mounting brackets 506A for receiving brackets 508A of bracket-based attachment components 508. This configuration allows for the attachment of various features to the WidePlate 506, enhancing its functionality and adaptability. The bracket-based attachment components 508 may include decorative elements, informational elements, or functional elements that can be attached to the WidePlate 506 using the brackets 508A. This configuration provides additional flexibility for customizing the WidePlate 506, as the bracket-based attachment components 508 can be easily added, removed, or replaced to change the appearance or functionality of the WidePlate 506. For example, bracket-based attachment components 508 may be snapped onto the WidePlate by mating receiving brackets 508A with mounting brackets 506A, allowing for quick and easy customization of the display area. This snap-on feature may provide a secure and convenient method for attaching and detaching various decorative or functional elements to the WidePlate. Of course, other means of quick attachment, such as an interference fit, buttons, or snaps are possible.

In addition to the mounting mechanisms described, the WidePlate may also utilize other methods to facilitate the mounting and removal of decorative components. For instance, the WidePlate could incorporate a hook-and-loop fastening system, such as Velcro, or a magnetic mounting system both of which would allow for quick and easy changes to the decorative elements. Alternatively, suction cups could be employed for temporary placement and easy repositioning of items on the WidePlate's surface. These various mounting options offer vehicle owners the ability to frequently update and personalize the appearance of their WidePlate without the use of tools or permanent alterations.

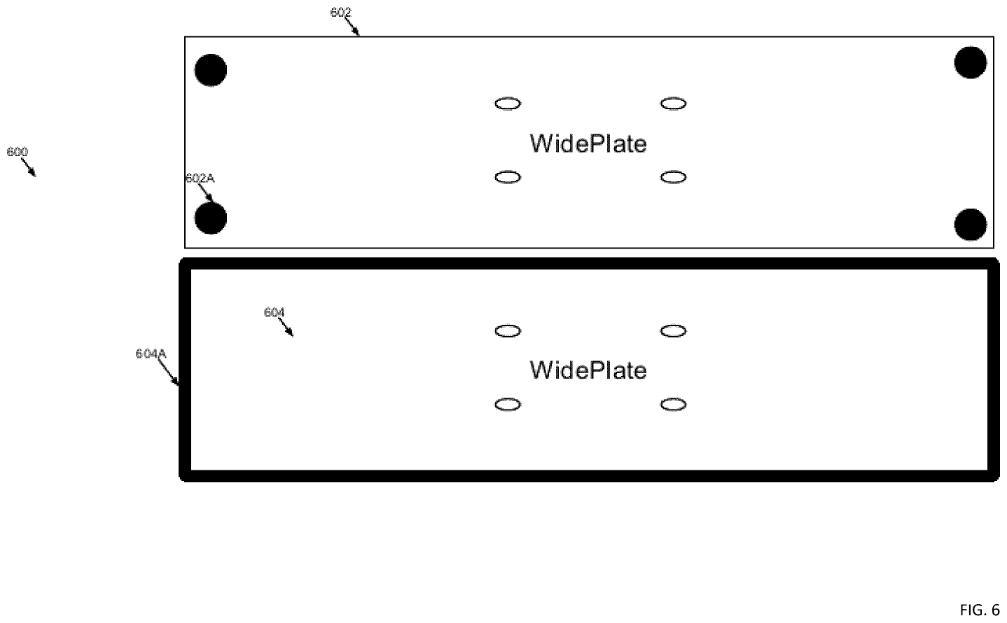

In some examples, as depicted in FIG. 6, the WidePlate may include protective features to prevent damage to the vehicle. FIG. 6 illustrates a view 600 of a WidePlate 602 having protective feet 602A, and a WidePlate 604 having a protective border 604A. These protective features are positioned on the backside or surrounding edges of the WidePlate to butt against the vehicle body, providing a buffer between the WidePlate and the vehicle to prevent scratches, dents, or other potential damage.

The protective feet 602A may be small protrusions or pads made from a soft or resilient material, such as rubber or foam. The protective fect 602A may be positioned at various points on the backside of the WidePlate 602, providing multiple points of contact with the vehicle body. This configuration may distribute the pressure exerted by the WidePlate 602 evenly across the vehicle body, reducing the risk of damage.

In contrast, the protective border 604A may be a continuous or segmented rim or edge that extends around the perimeter of the backside of the WidePlate 604. The protective border 604A may be made from a soft or resilient material, such as rubber or foam, and may provide a cushion between the WidePlate 604 and the vehicle body. This configuration may prevent the edges of the WidePlate 604 from scratching or denting the vehicle body, protecting the vehicle from potential damage.

In some cases, the protective feet or edge may be designed to compress against the vehicle body when the WidePlate is mounted. This compression serves to eliminate any movement of the WidePlate relative to the vehicle, ensuring that the WidePlate remains securely in place during vehicle operation. The compression of these protective elements not only provides stability to the WidePlate and reduces noise but also acts as a safeguard against vibration-induced wear, which could otherwise lead to abrasion or other damage to the vehicle's body. By maintaining a firm yet cushioned contact with the vehicle, the WidePlate's protective features contribute to both the aesthetic integrity and the preservation of the vehicle's surface.

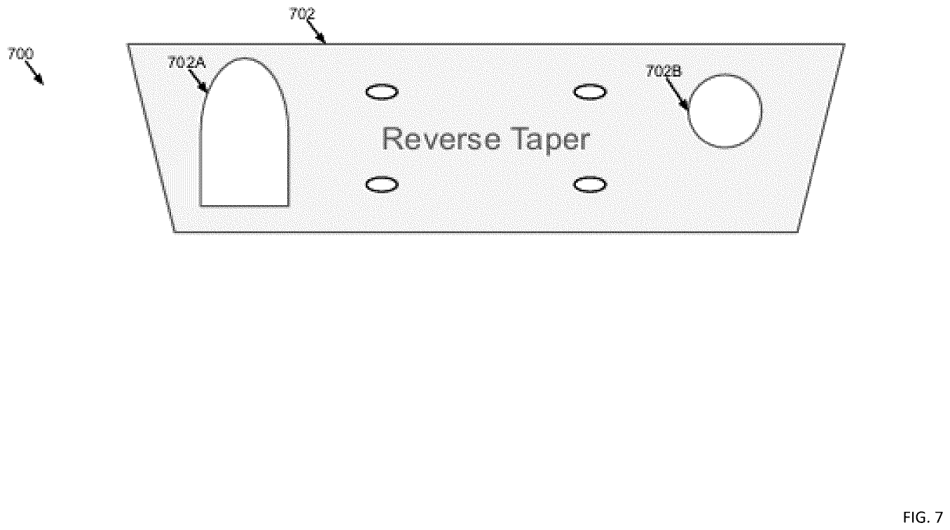

In some examples, as depicted in FIG. 7, the WidePlate may include at least one cutout portion configured to accommodate vehicle obstructions. These cutout portions may be strategically positioned on the body of the WidePlate 702 to align with the specific layout of the vehicle's features, providing a customized fit that seamlessly integrates with the vehicle's design.

The configuration in FIG. 7 illustrates a view 700 of a reverse taper WidePlate 702, which features a semi-circular cutout 702A and a circular cutout 702B. These cutouts are positioned on the body of the WidePlate 702 to align with and avoid interference with vehicle features when the WidePlate is mounted to the vehicle.

In some cases, the semi-circular cutout 702A and the circular cutout 702B may be designed to accommodate specific vehicle features, such as lights, sensors, power outlets, trailer connections, or other components that may be located near the license plate area. This configuration allows the WidePlate 702 to be mounted on the vehicle without obstructing these features, ensuring that the vehicle's functionality is not compromised.

In either case, the area around the cutouts on the WidePlate, such as the semi-circular cutout 702A and the circular cutout 702B depicted in FIG. 7, may serve as additional space for decorative purposes. This space can be utilized by vehicle owners to further personalize their vehicles with decorative elements that complement or highlight the vehicle's features. In other words, the pace around the cutouts may be adorned with custom graphics, trim accents, or lighting that enhances the visual appeal of the WidePlate and the vehicle, while also accommodating the functional aspects of the vehicle's design, such as external sensors or lighting fixtures. This design consideration allows for a harmonious integration of practicality and personal style, offering a tailored aesthetic that aligns with the vehicle owner's preferences and the vehicle's existing features.

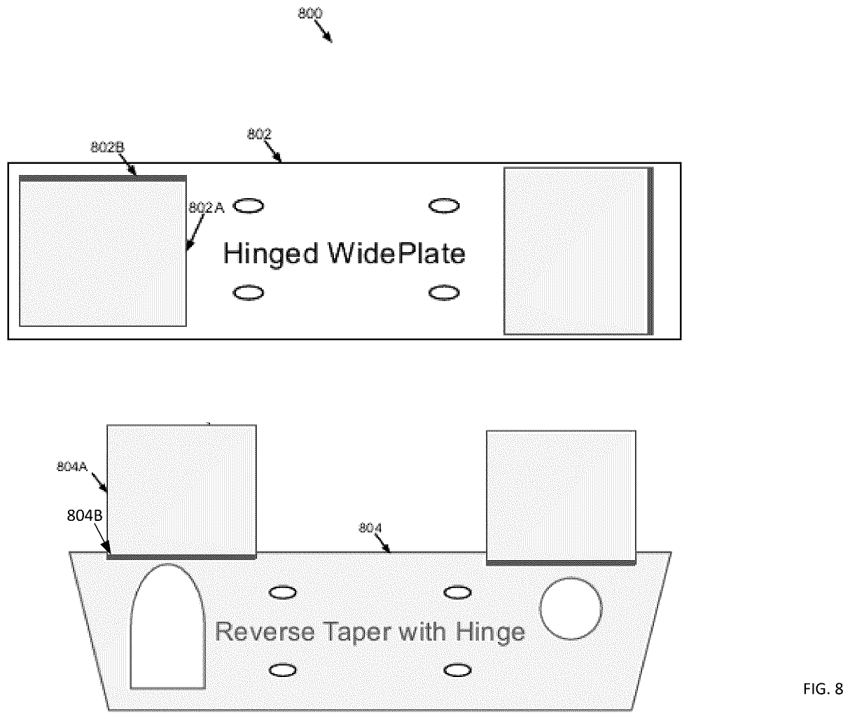

In some examples, as depicted in FIG. 8, the WidePlate may include at least one hinged feature that allows the display area of the WidePlate to move relative to a central portion of the WidePlate. FIG. 8 illustrates view 800 of a hinged WidePlate 802 with a hinged display area 802A connected to the WidePlate via a hinge 802B. This configuration allows for the display area of the WidePlate 802 to pivot or fold, providing easy access to the license plate or other vehicle features. This movement may also be facilitated by various other mechanisms, such as a pivot, a sliding track, or a flexible joint.

In some examples, the WidePlate may feature a reverse taper design with a hinged display feature, as illustrated by the reverse taper hinged WidePlate 804 with a hinged feature 804A connected via a hinge 804B. This design variation combines the benefits of the reverse taper design, which provides a customized fit for vehicles with a contrasting contour, with the functionality of the hinged feature 804A. The hinged feature 804A allows the display area of the reverse taper hinged WidePlate 804 to move relative to a central portion of the WidePlate, providing easy access to the license plate or other vehicle features. It should be noted that any embodiments have interchangeable components and can be combined in any way needed to accommodate a particular vehicle or a customer's interest.

In either case, the hinged display area of the WidePlate effectively serves a dual purpose by covering functional portions of the vehicle, such as cutouts for vehicle components, while also being movable to allow access to these components. For example, when not in use, the hinged display area can cover a power outlet that protrudes through the WidePlate, maintaining the aesthetic continuity of the WidePlate's design and maximizing the display area(s). When access to the power outlet or other vehicle features is desired, the hinged display area can be easily moved aside, providing convenient and unobstructed access to the underlying vehicle components. This feature enhances the utility of the WidePlate by allowing it to adapt to the vehicle's functional requirements without compromising on design or convenience.

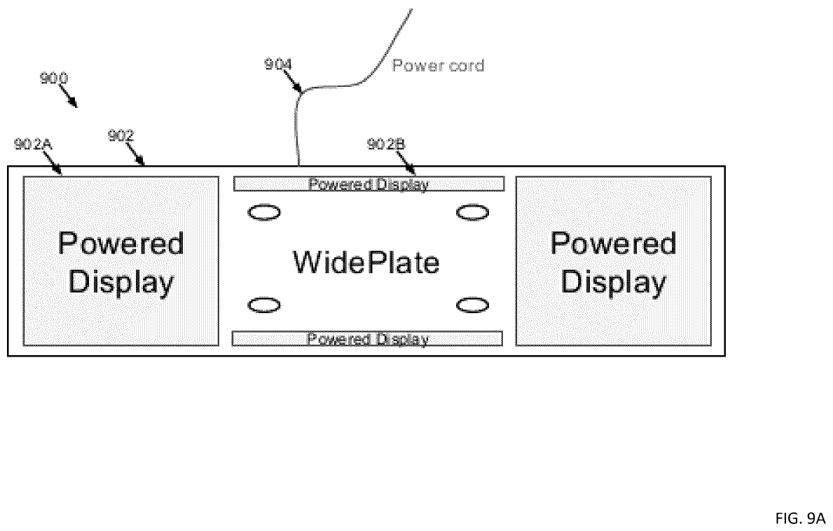

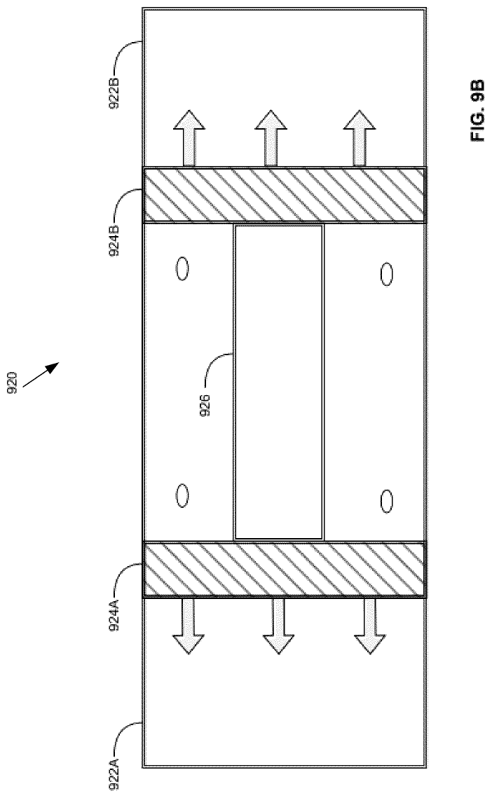

In some examples, as depicted in FIG. 9A, the WidePlate 902 may include a powered display (e.g. light emitting diode (LED) display, liquid crystal display (LCD), etc.) in the display area. FIG. 9A illustrates a view 900 of a powered WidePlate 902 having left/right powered displays 902A and top/bottom powered displays 902B powered by an electrical power cord 904. This configuration allows for the display of digital text or images on the WidePlate 902, enhancing its functionality and adaptability. The powered displays 902A, 902B may include various types of electronic displays, such as LED displays, LCD displays, or digital screens. These displays may be individually or collectively configured to display various types of information or designs, such as vehicle information, personalized messages, or decorative patterns.

In some cases, the powered displays 902A, 902B may be configured to receive electrical power through an electrical power cord 904. This power cord 904 may be connected to a power source on the vehicle, such as the vehicle's electrical system or a separate battery. This configuration allows for the powered displays 902A, 902B to be continuously powered while the vehicle is in operation, ensuring that the displayed information or designs are consistently visible. In another example, powered displays 902A, 902B may be configured to receive electrical power from a battery (not shown but could be mounted behind the WidePlate or License Plate) that is powered (i.e., charged) by photovoltaic cells (not shown but could be mounted in front of the WidePlate to the side(s) of the License Plate).

In some examples, the display area of the WidePlate may be enhanced with the capability to exhibit custom icons and messages selected by the user. This may be achieved through programming by an internal controller mounted to the Wideplate. The controller may include a processor, memory, user interface, and wired/wireless interface for programming purposes. The programming may be performed locally on the user interface of the controller or wirelessly via e.g., a smartphone application in communication with the controller, offering a high degree of personalization and convenience. The user can choose from a variety of pre-designed icons or create custom messages that reflect their personal style or convey information, such as business advertisements or alerts. This feature adds a dynamic aspect to the WidePlate, allowing the display to be updated as frequently as desired to suit changing preferences or communication needs.

In some embodiments, the WidePlate assembly may include edge lit displays. For example, as shown in FIG. 9B, WidePlate assembly 920 may be equipped with a central license plate area that houses a battery 926. The license plate may be mounted in central license plate area thereby covering battery 926. Flanking this central area are a left side panel 924A and a right side panel 924B, each embedded with photovoltaic cells for harnessing solar energy to recharge battery 926. Side panels 924A and 924B are further enhanced with edge illumination sources, such as light-emitting diodes (LEDs), which are adept at providing a uniform light distribution (in the direction of the arrows) to left side edge-lit illumination display 922A and the right side edge-lit illumination display 922B. It should be noted that the direction of the edge-lit illumination is not limited to the direction shown in the figure, and therefore could be directed upwards or downwards to create an edge-lit illuminated display above or below the license plate. These displays may be crafted from a transparent or translucent material like acrylic, are designed to diffuse light across their surface, creating a luminous backdrop for graphics or messages. The edge illumination technique amplifies the clarity and legibility of the displays, making them more striking, especially in low-light conditions. This combination of photovoltaic technology and edge illumination in the WidePlate assembly 920 offers a sustainable power source while simultaneously delivering a customizable and visually captivating display feature. The edge-lit displays can be tailored to the user's preferences, serving a multitude of purposes from artistic expression to practical signaling. This fusion of green energy solutions with customizable edge-lit displays underscores the WidePlate's dedication to pioneering, eco-conscious, and personalized vehicle accessory designs.

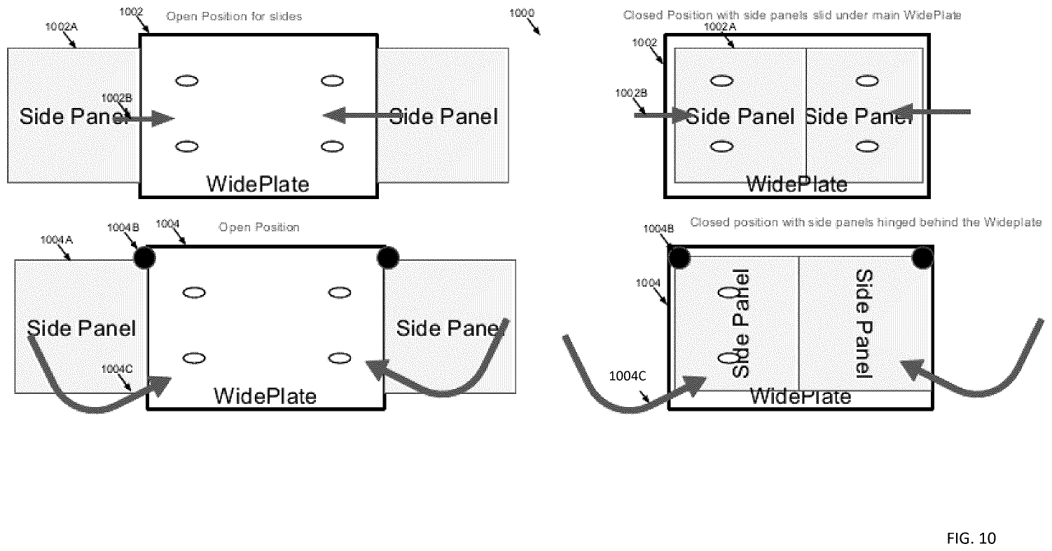

In some examples, as depicted in FIG. 10, the WidePlate may include side panels that are either slidable, hinged, or pivotable. FIG. 10 illustrates view 1000 showing a WidePlate 1002 with slidable side panels 1002A. These slidable side panels 1002A may be designed to move horizontally along the back surface of the WidePlate 1002, providing flexibility in the positioning of the side panels. The sliding movement 1002B of the side panels 1002A may be facilitated by various mechanisms, such as a sliding track, a rail, or a groove on the WidePlate 1002. This configuration allows for the side panels 1002A to be easily extended or retracted, allowing the user to deploy the side panels when desired and hide the side panels when desired. More specifically, the side panels 1002A are designed to slide behind the main body of the WidePlate 1002 when retracted and slide out from behind the WidePlate when deployed. This design allows for a streamlined appearance, as the side panels can be concealed behind the WidePlate when not in use. The sliding mechanism enables the side panels to move smoothly and remain attached to the WidePlate, ensuring that they are readily available for deployment when additional display area is desired. This feature provides a versatile solution for vehicle owners who may want to temporarily conceal their display areas.

In other examples, the WidePlate may include pivotable side panels, as illustrated by the WidePlate 1004 with pivotable side panels 1004A. These pivotable side panels 1004A may be designed to rotate or pivot relative to the WidePlate 1004, providing flexibility in the positioning of the side panels. The pivoting movement 1004C of the side panels 1004A may be facilitated by pivot mechanism 1004B on the WidePlate 1004. Similar to the sliding configuration, this pivoting configuration also allows for the side panels 1004A to be deployed when desired and hidden behind the WidePlate when desired.

In addition to the hinged and sliding mechanisms described, the WidePlate may incorporate other methods to facilitate the concealment and exposure of the display areas. For instance, a foldable design may be employed, allowing sections of the display area to be folded against the WidePlate to conceal them or unfolded to reveal them. These various mechanisms provide vehicle owners with the flexibility to adjust the visibility of their customizations and maintain the aesthetic appeal of their vehicle as desired.

In some examples, the display areas of the WidePlate are manually adjustable by the user, allowing for the customization of the vehicle's appearance according to personal preference or functional requirements. The user can manually move the display areas slide/pivot them behind the WidePlate when desired and then manually slide/pivot them out to their display positions. Alternatively, this may be achieved automatically through electro-mechanical actuation and programming by an internal controller mounted to the Wideplate. For example, electro-mechanical actuators e.g., linear actuators, rotational actuators, etc. (not shown) may be positioned behind the Wideplate to slide/pivot the display areas when desired. The controller may include a processor, memory, user interface, and wired/wireless interface for programming purposes. The programming may be performed locally on the user interface of the controller or wirelessly via e.g., a smartphone application in communication with the controller, offering an option (e.g., soft button) for the user to control (i.e., apply power to) the electro-mechanical actuators to slide/pivot the display areas when desired.

The ability to conceal or minimize the display area of the WidePlate can be particularly advantageous in situations where a more subdued or formal aesthetic is desired. For instance, when attending formal events such as weddings, funerals, or high-profile business meetings, the presence of a vibrant or personalized license plate display may not be suitable or may detract from the overall elegance of the vehicle. In such scenarios, the user can easily slide or pivot the display areas of the WidePlate behind the main body, effectively concealing any decorative elements and presenting a more streamlined and understated appearance. This feature allows the vehicle owner to adapt the look of their vehicle to match the tone of the event, demonstrating respect for the occasion and attention to detail. Furthermore, this feature can also be beneficial in situations where the vehicle owner wishes to maintain a low profile or avoid drawing attention to their vehicle, such as in high-traffic areas or when parking in unfamiliar locations. Thus, the WidePlate's adjustable display areas offer a versatile solution for vehicle owners, allowing them to easily modify the appearance of their vehicle to suit a variety of situations and preferences.

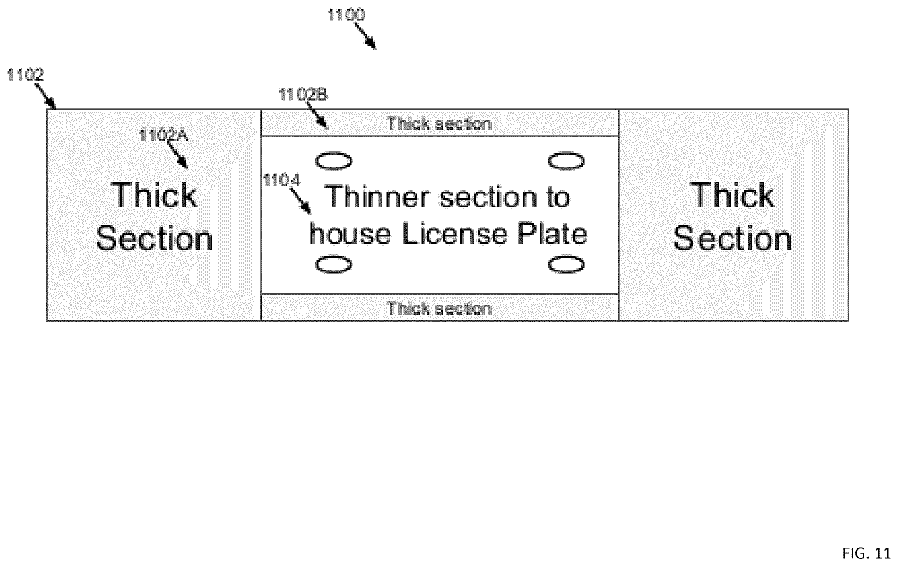

In some examples, as depicted in FIG. 11, the WidePlate may be designed with areas of varying thicknesses to accommodate different vehicle contours, strength requirements, or to provide a recessed area for the license plate. FIG. 11 illustrates view 1100 of a WidePlate 1102 having left/right thick sections 1102A and top/bottom thick sections 1102B, and a central thinner section 1104. This configuration allows the WidePlate 1102 to conform to the specific contour of the vehicle, providing a customized fit that seamlessly integrates with the vehicle's design.

In some cases, the left/right thick sections 1102A and top/bottom thick sections 1102B of the WidePlate 1102 may be designed to provide additional rigidity or durability to the WidePlate 1102. These thick sections 1102A, 1102B may be made from a durable material, such as plastic or metal, and may be designed to withstand the rigors of vehicle dynamics and outdoor exposure, including weather conditions, road debris, and other potential sources of damage.

In other examples, the central thinner section 1104 of the WidePlate 1102 may be designed to accommodate a standard vehicle license plate. This thinner section 1104 may be recessed relative to the thick sections 1102A, 1102B, providing a space for the license plate to be mounted flush with the surface of the WidePlate 1102. This configuration allows for the license plate to be easily viewed and read, while also protecting the license plate from potential damage.

In some examples, the thick sections of the WidePlate, such as the left/right thick sections 1102A and top/bottom thick sections 1102B, may not just provide structural benefits but also contribute to a more robust and prominent look for the display area. These thick sections may serve as a bold frame for the information or decorative elements displayed, enhancing their visibility and impact. The additional volume provided by the thick sections can create a sense of depth and prominence, making the WidePlate an even more striking accessory on the vehicle and offering a substantial canvas for vehicle owners to express their personal style or convey information effectively. As mentioned before, if the WidePlate includes at least a transparent portion made of a material such as clear acrylic, it may be mounted on top of the license plate.

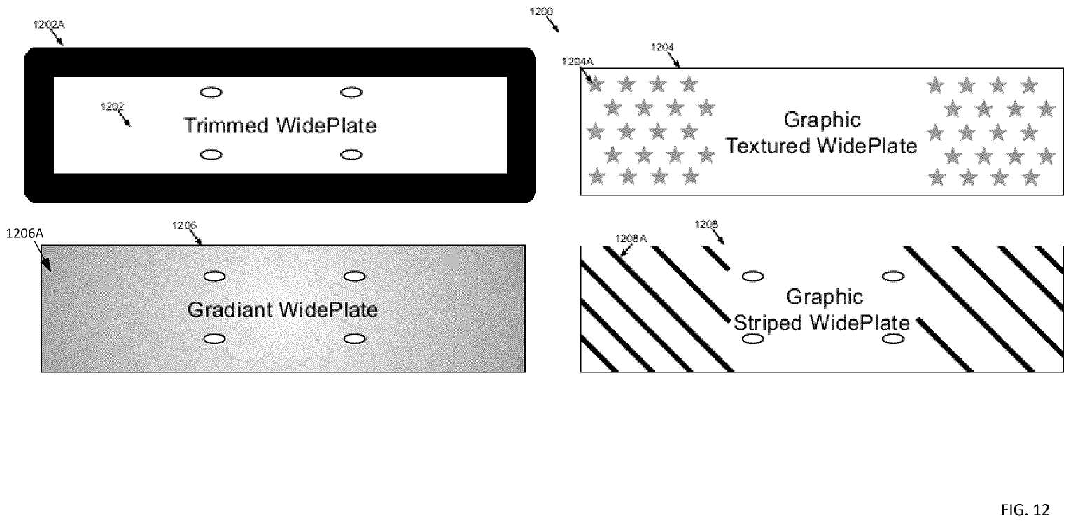

In some examples, as depicted in FIG. 12, the WidePlate may be designed with various aesthetic features to enhance its visual appeal. FIG. 12 illustrates view 1200 of several variations of the WidePlate design, each with a distinct aesthetic feature.

The trimmed WidePlate 1202, for instance, includes a trim 1202A that contrasts with the main body of the WidePlate 1202. This trim 1202A may be made from a different material or colored differently than the main body of the WidePlate 1202, providing a visually striking contrast that enhances the aesthetic appeal of the WidePlate 1202.

In other examples, the WidePlate may feature a graphic texture, as illustrated by the graphic textured WidePlate 1204. This design variation includes a graphic texture 1204A that covers the surface of the WidePlate 1204. The graphic texture 1204A may include various patterns, designs, or images, providing a visually interesting surface that enhances the aesthetic appeal of the WidePlate 1204.

In yet other examples, the WidePlate may feature a color gradient, as shown by the gradient WidePlate 1206. This design variation includes a gradient 1206A that transitions from one color to another across the surface of the WidePlate 1206. This gradient 1206A may create a visually striking effect, enhancing the aesthetic appeal of the WidePlate 1206.

In some cases, the WidePlate may also feature a graphic strip, as illustrated by the graphic striped WidePlate 1208. This design variation includes a graphic strip 1208A that extends across the surface of the WidePlate 1208. The graphic strip 1208A may be colored differently than the main body of the WidePlate 1208, providing a visually striking contrast that enhances the aesthetic appeal of the WidePlate 1208. The graphic strip may also include text or the like.

These variations in the WidePlate design, each with a different aesthetic feature, are designed to enhance the visual appeal of the WidePlate. This aesthetic customization allows for a wide range of design options, enhancing the aesthetic appeal and utility of the WidePlate and the vehicle to which it is attached.

The customization options of the WidePlate extend beyond mere functionality, offering vehicle owners the opportunity to express their individuality and preferences through their favorite colors, designs, team logos, and more. By providing a canvas for personal expression, the WidePlate allows for a level of personalization that reflects the owner's personality, whether it be through vibrant hues, intricate patterns, or symbols of personal or professional affiliations. This feature of the WidePlate not just enhances the aesthetic appeal of the vehicle but also serves as a medium for owners to make a statement or showcase their passions, making each WidePlate as distinctive as the individual behind the wheel.

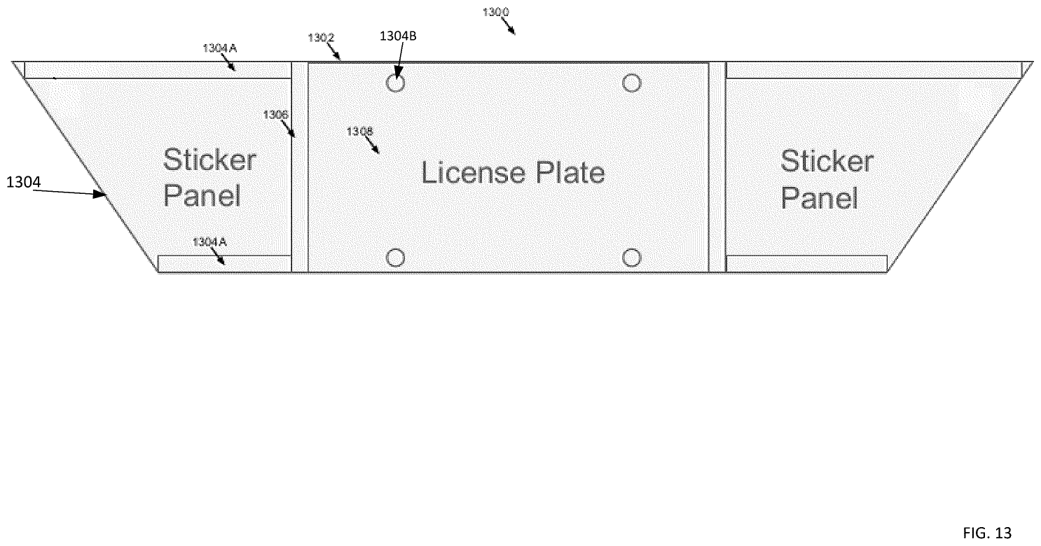

In FIG. 13, view 1300 provides another detailed illustration of an embodiment of the WidePlate. The WidePlate 1302 is designed with a removable sticker panel 1304, which can be inserted into designated slots on the WidePlate. These slots, labeled as top/bottom slots 1304A and side slots 1306, are strategically positioned to securely hold the sticker panel 1304 in place. Mounting holes 1304B are also provided.

The inclusion of a removable sticker panel 1304 in the WidePlate 1302 design offers a high degree of customization for the vehicle owner. Stickers, decals, or other adhesive-backed decorative elements can be applied to the sticker panel 1304, rather than directly onto the WidePlate 1302 or the vehicle itself. This allows for easy and frequent changes to the displayed elements, as the sticker panel 1304 can be conveniently removed and replaced with a new panel featuring a different design.

The sticker panel 1304 is designed to fit snugly into the slots 1304A, 1306 on the WidePlate 1302, ensuring a secure fit and a seamless appearance. The top/bottom slots 1304A and side slots 1306 are designed to accommodate the sticker panel 1304, allowing it to slide into place easily. Once inserted, the sticker panel 1304 sits flush with the surface of the WidePlate 1302, maintaining the sleek and streamlined appearance of the WidePlate.

This configuration of the WidePlate 1302 with a removable sticker panel 1304 provides a practical and user-friendly solution for vehicle owners who wish to frequently update or change the decorative elements displayed on their vehicle. The ability to easily insert and remove the sticker panel 1304 allows for quick and hassle-free customization, enabling vehicle owners to express their personal style or convey information through the WidePlate 1302. The removable sticker panel is, of course, not limited to the reverse taper WidePlate and can be configured to all shapes, sizes, and contours of WidePlates.

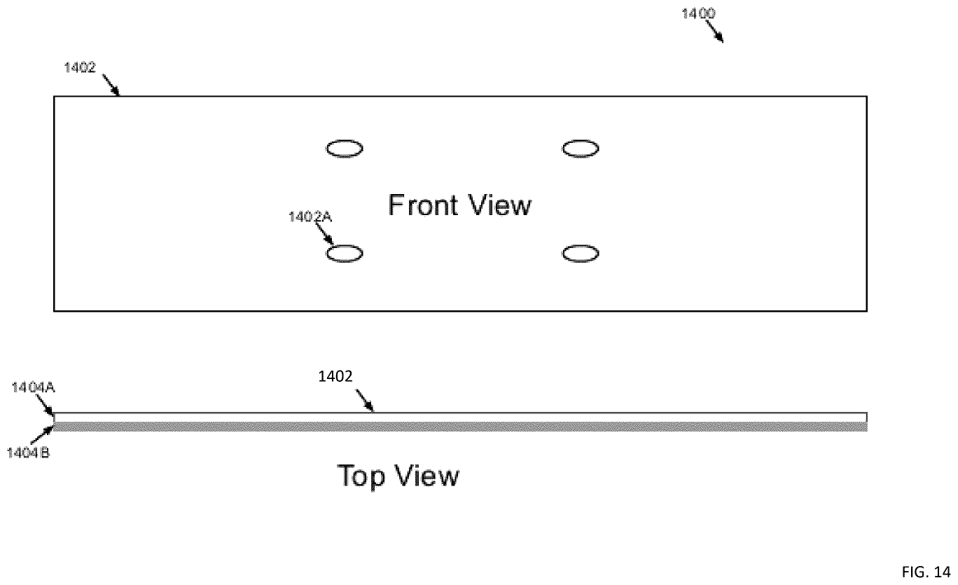

In some examples, as depicted in view 1400 of FIG. 14, the WidePlate 1402 may include a magnetic back layer 1404B, providing the capability for magnetic attachment to the vehicle. FIG. 14 illustrates front/top views of the WidePlate 1402 having mounting holes 1402A, a WidePlate layer 1404A, and a magnetic layer 1404B.

Similar to other configurations, the WidePlate 1402 is secured to the vehicle using fasteners inserted through the WidePlate mounting holes 1402A and aligned with the vehicle's license plate mounting holes. This fastening mechanism ensures that the WidePlate 1402 is firmly attached to the vehicle, providing a stable and durable installation. The magnetic layer 1404B acts as an auxiliary holding force, supplementing the security provided by the fasteners. This additional magnetic adhesion helps to prevent any movement of the WidePlate 1402 that could be caused by wind forces or vibrations from the vehicle's operation. The combination of fastening and magnetic attachment offers a dual security system, ensuring that the WidePlate 1402 remains securely in place under various driving conditions while still allowing for the convenience of easy removal and repositioning if desired.

The WidePlate's innovative design effectively introduces a transformative approach to vehicle customization, providing a mechanism for extending the display area beyond the traditional confines of a license plate. This additional space allows vehicle owners to showcase a variety of decorative or informational elements, effectively turning the license plate area into a canvas for personal expression. The WidePlate's mounting configuration is designed to align with the existing mounting holes of a standard vehicle license plate, facilitating a seamless integration with the vehicle body. By mounting the WidePlate behind the license plate, the display area is not just visible but also strategically positioned to enhance the vehicle's aesthetic without compromising the visibility of the license plate itself providing an unobstructed view of license plate information. Of course, the WidePlate could be mounted in front of the license plate if the WidePlate includes a cutout or transparent portion that provides an unobstructed view of the license plate information.

The functionality of the WidePlate is further highlighted by its adaptability to the vehicle's bodywork. Whether the vehicle features a flat, contoured, or uniquely shaped license plate area, the WidePlate can be configured to match, providing a customized fit that complements the vehicle's design. This adaptability is achieved through various WidePlate configurations, such as tapered edges or areas of varying thickness, which accommodate different vehicle contours and provide a recessed area for the license plate when desired. The result is a robust and secure attachment that not just adds to the vehicle's visual appeal but also offers a durable solution capable of withstanding the elements and the rigors of the road.

While the foregoing is directed to example embodiments described herein, other and further example embodiments may be devised without departing from the basic scope thereof. It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A wideplate for attachment to a vehicle, comprising:
a body larger than a standard vehicle license plate, wherein a portion of the body extending beyond a perimeter of the license plate provides a display area; and
a plurality of wideplate mounting holes,
wherein the wideplate mounting holes are configured to align with license plate mounting holes to enable the wideplate to be mounted behind or in front of the vehicle license plate, such that the display area is visible beyond the perimeter of the license plate.

2. The wideplate of claim 1, wherein the body comprises a tapered edge for conforming to a contour of the vehicle.

3. The wideplate of claim 1, wherein the display area comprises embossed or debossed features.

4. The wideplate of claim 1, wherein the display area comprises at least a flat area for receiving stickers.

5. The wideplate of claim 1, wherein the display area comprises mounts for receiving attachable features.

6. The wideplate of claim 1, further comprising protective features comprising at least one of protective feet and a protective border, wherein the protective features are positioned on at least the backside of the wideplate to butt against the vehicle body.

7. The wideplate of claim 1, further comprising at least one hinged feature allowing the display area of the wideplate to move relative to a central portion of the wideplate.

8. The wideplate of claim 1, wherein the display area comprises a powered display configured to receive electrical power through an electrical power cord or photovoltaic battery power source.

9. The wideplate of claim 1, further comprising at least one cutout portion configured to accommodate vehicle obstructions, wherein the cutout portion is positioned on the body of the wideplate to align with and avoid interference with vehicle features when the wideplate is mounted to the vehicle.

10. The wideplate of claim 1, wherein the body comprises a magnetic layer, providing a capability for magnetic attachment to the vehicle.

11. A method for installing a wideplate on a vehicle, the method comprising:
positioning the wideplate in between the vehicle and a license plate; and
aligning a plurality of wideplate mounting holes with license plate mounting holes to mount the wideplate behind or in front of the vehicle license plate,
wherein the wideplate comprises a body larger than the license plate to the vehicle, where a portion of the body extends beyond a perimeter of the license plate providing a display area visible beyond the perimeter of the license plate.

12. The method of claim 11, wherein the wideplate comprises a tapered edge for conforming to a contour of the vehicle, and the method further comprises aligning the tapered edge with the contour of a vehicle.

13. The method of claim 11, wherein the wideplate comprises embossed or debossed features in the display area, and the method further comprises pressing the license plate against a central portion of the wideplate between the embossed or debossed features.

14. The method of claim 11, wherein the wideplate comprises at least a flat area for receiving stickers in the display area, and the method further comprises applying stickers to the flat area.

15. The method of claim 11, wherein the wideplate display area comprises mounts for receiving attachable features in the display area, and the method further comprises attaching display features to the mounts.

16. The method of claim 11, wherein the wideplate further comprises protective features comprising at least one of protective feet and a protective border, and the method further comprises positioning the protective features against the vehicle body to prevent damage when installed.

17. The method of claim 11, wherein the wideplate further comprises at least one hinged feature, and the method further comprises moving the display area of the wideplate relative to a central portion of the wideplate via the hinged feature during installation.

18. The method of claim 11, wherein the wideplate comprises a powered display in the display area, and the method further comprises connecting the powered display to an electrical power source via an electrical power cord or photovoltaic battery power source during installation.

19. The method of claim 11, wherein the wideplate further comprises at least one cutout portion configured to accommodate vehicle obstructions, and the method further comprises aligning the cutout portion with vehicle features to avoid interference during installation.

20. The method of claim 11, wherein the wideplate comprises a magnetic layer, and the method further comprises magnetically attaching the wideplate to the vehicle during installation.
